(19) United States
(12) Patent Application Publication
(10) Pub. No.: US 2016/0001225 A1
(43) Pub. Date: Jan. 7, 2016

(54) EXHAUST GAS CLEAN-UP SYSTEM FOR FOSSIL FUEL FIRED POWER PLANT

(71) Applicants: Lai O. Kuku, Gilbert, AZ (US); Andre M. Fuentes, Maricopa, AZ (US)

(72) Inventors: Lai O. Kuku, Gilbert, AZ (US); Andre M. Fuentes, Maricopa, AZ (US)

(21) Appl. No.: 14/324,200

(22) Filed: Jul. 6, 2014

(51) Int. Cl. B01D 53/86; B01D 53/62; B01D 53/50

(52) U.S. Cl. CPC B01D 53/864; B01D 53/507; B01D 53/8631; B01D 53/62; B01D 2251/404; B01D 2251/604

(57) ABSTRACT

A fossil fuel fired power plant exhaust gas clean-up system is provided to remove detrimental compounds/elements from the exhaust gas emitting from the power plant to protect the environment. The removal of detrimental compounds/elements is accomplished by directing the exhaust gas thought several process steps. For example, one step includes a wet scrubber that includes the exhaust gas, water, and a chemically produced compound. The chemical reaction therein is effective to remove sulfur from the exhaust gas and as a side benefit, a useful by-product is produced and stored. Another step directs the remaining exhaust gas through a catalytic converter that is effective to convert nitrogen oxide to nitrogen gas and converts carbon monoxide into carbon dioxide. The final step includes directing the remaining exhaust gas into a reaction chamber with the addition of a reacting compound to remove the carbon dioxide and produce a chemical compound that is used in the first step. The final exhaust gas can now be safely exhausted to the atmosphere and only contains nitrogen gas, oxygen, water and a trace amount of carbon dioxide.

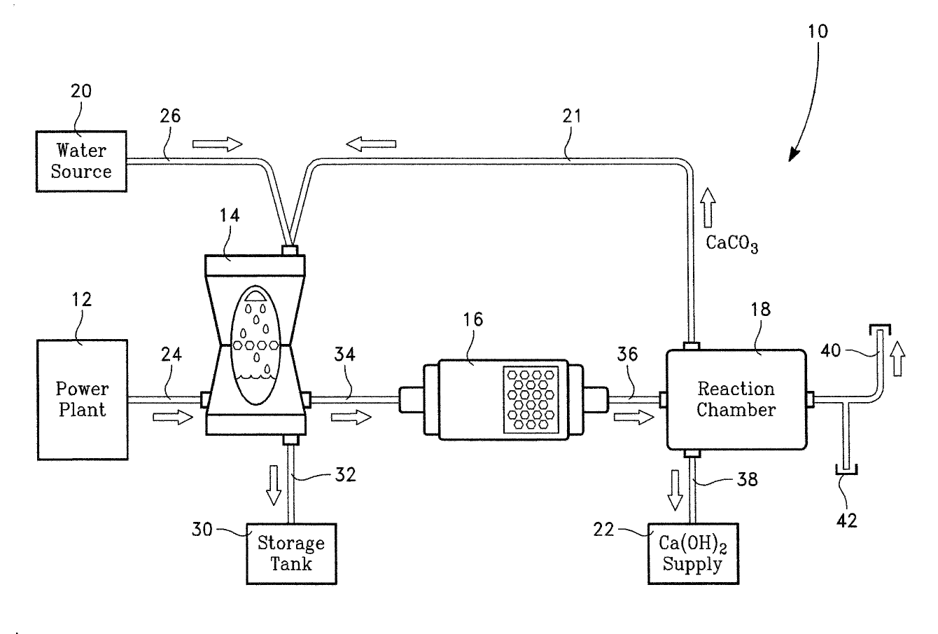

### TECHNICAL FIELD

The subject design relates generally to an exhaust gas clean-up system that helps to remove some detrimental exhaust gas compositions and more specifically relates to a process and apparatus that processes exhaust gas from a fossil fuel fired power plant to remove detrimental exhaust gas compositions.

### BACKGROUND

There have been many different arrangements that attempt to remove detrimental flu gas compositions but most of them are only partially effective in removing most if not all of the detrimental exhaust gas compositions. This many times is based on the extreme cost of effective types of exhaust gas removal systems. Emissions of nitrogen oxides into the atmosphere can result in the generation of ozone in our atmosphere. Ozone is important in our higher altitudes since it helps to offset the effects of the sun's damaging rays on the earth. However, ozone can be a hazard to humans when it is within our habitable altitude. Another emitted gas that is detrimental is nitrogen oxides. It reacts with atmospheric water and causes acid rain. Likewise, sulfur dioxides has been a big problem when exhausted into the atmosphere. The subject design serves as a possible solution to at least the above noted detrimental exhaust gases.

### SUMMARY OF THE INVENTION

According to the present design, an exhaust gas clean-up system is provided that is effective to remove various detrimental gases from a fossil fuel fired power plant. The subject system includes a process having various operational steps. The steps generally include directing the exhaust gas through a wet scrubber, adding a chemically produced compound from another source to the wet scrubber, adding water to the wet scrubber to mix with the exhaust gas and the chemically produced compound, bypassing a chemically produced byproduct from the wet scrubber. The next step includes directing the chemically modified exhaust gas through a catalytic converter to further chemically modify the exhaust gas, then directing the further chemically modified exhaust gas to a reaction chamber for additional modification. In the reaction chamber, a reacting compound is added to aid in the additional modification of the exhaust gas therein. A chemically produced compound is produced in the reactor chamber and directed to the wet scrubber to serve as the another source noted above. The final chemically modified exhaust gas is now ready to be released to the atmosphere.

The sequence of the various steps and the interaction therebetween permits the production of various byproducts, and which in some instances permit the use of the byproducts in the chemical reaction of compounds in other parts of the process.

Other objects, features, and advantages of the subject design will become more apparent from the following detailed description of the following embodiment and certain modification thereof when taken together with the accompanying drawing.

### BRIEF DESCRIPTION OF THE DRAWINGS

The sole drawing is a partial flow chart and a partial diagrammatic representation of the subject design.

### DETAILED DESCRIPTION

Referring to the sole drawing, an exhaust gas clean-up system 10 is provided. The exhaust gas clean-up system 10 is connected to the exhaust of a typical fossil fuel fired power plant 12. The exhaust gas from the power plant 12 contains various percentages of carbon dioxide (CO₂), water (H₂), nitrogen (N), sulfur dioxide (SO₂), and nitrogen oxides (NOₓ). The gas clean-up system 10 includes a wet scrubber 14, a catalytic converter 16, a reaction chamber 18, a source of water 20, a source of a chemically produced compound connecting line 21, and a source of reacting compound 22.

The wet scrubber is connected to the exhaust of the power plant 12 by an exhaust gas connection line 24 and to the source of water 20 by a water connection line 26. The source 22 of the chemically produced compound is, in the subject arrangement, the reacting chamber 18 and is connected to the wet scrubber by a compound connection line 21. The chemical reaction within the wet scrubber 14 produces a usable by-product and acts to remove the sulfur by the chemical reaction between the sulfur dioxide in the exhaust gas, the slurry of water and calcium carbonate as seen below:

SO₂+CaCO₃+1/2O₂+2H₂O=CaSO₄(2H₂O)+CO₂

This reaction consumes calcium carbonate, water, and oxygen in order to convert sulfur dioxide into CaSO₄(2H₂O) which can be utilized in various ways as gypsum. The by-product of gypsum is directed to a holding tank 30 by a bypass line 32. This reaction cleans up the sulfur dioxide that was contained in the exhaust gas.

The chemically modified exhaust gas is now directed to the catalytic converter 16 by the converter connecting line 34 further chemically modifying the exhaust gas. The catalytic converter 16 can be a typical catalytic converter used in most automobiles. However, a platinum converter with an internal honeycomb arrangement is more effective even though the use of the platinum converter does not depart from the essence of the subject invention.

Within the subject catalytic converter 16, the nitrogen oxides are converted into carbon dioxide (CO₂) and water (H₂O). The residual carbon monoxide (CO) is converted into carbon dioxide (CO₂) and water (H₂O). At this point within the design, the nitrogen oxides (NOₓ) and the sulfur oxides (SO₂) have been addressed and that which is left is carbon dioxide (CO₂), nitrogen gas (N), water (H₂O), and oxygen (O₂).

In order to help reduce carbon dioxide (CO₂) emissions as well as provide the wet scrubber 14 with the chemically produced compound, i.e. calcium carbonate (CaCO₃) and water, the further chemically modified exhaust gas is passed to the reaction chamber 18 through a reacting connection line 36. The source of reacting compound, i.e. calcium hydroxide (Ca(OH)₂, is introduced in the reaction chamber 18 through a reacting compound line 38.

The chemical reaction within the reaction chamber is as follows:

Ca(OH)₂+CO₂=CaCO₃+H₂O

The calcium carbonate (CaCO₃) and water are directed from the reaction chamber 18 to the wet scrubber 14 as the source of chemically produced compound and to add water thereto also. The source of chemically produced compound and water from the reaction chamber 18 are returned through the source of compound connecting line 21.

This process reduces the carbon dioxide (CO₂) levels to a trace.

At this point in the process, the final chemically modified exhaust gas can be safely emitted into the atmosphere through an exhaust line 40. Any water that is passing through the exhaust line 40 can be bypassed to a water tank 42.

### INDUSTRIAL APPLICABILITY

The subject process for exhaust gas clean-up provides a simple, safe, cost effective and an excellent process for removing detrimental compounds/elements from the exhaust of a fossil fuel fired power plant 12.

By passing the exhaust gas from the power plant 12 through a wet scrubber 14 having a solution of water, calcium carbonate (CaCO₃), oxygen (O₂), and sulfur dioxide (SO₂) therein, the sulfur is chemically removed and the by-product of the gypsum slurry (CaSO₄(2H₂O) is directed to a storage tank 30. During the reaction within the wet scrubber 14, the calcium carbonate (CaCO₃), water (H₂O), and oxygen (O₂) is consumed to convert the sulfur dioxide (SO₂) to the gypsum slurry (CaSO₄(2H₂O). Even though the wet scrubber 14, is connected to the remote source of waster 20, the water being produced in the reaction chamber 18 and directed to the wet scrubber 14 through the source compound connection line 21 during the production of the calcium carbonate (CACO₃) is normally sufficient.

The chemically modified exhaust gas is passed through the catalytic converter 16 to provide chemical reaction like that of catalytic converters in automobiles. As previously stated, within the catalytic converted 6, the nitrogen oxides (NO₂) converts into nitrogen gas (N) and oxygen (O₂), any residual carbon monoxide (CO) converts into carbon dioxide (CO₂), and the residual hydrocarbons converts into carbon dioxide (CO₂) and water. The only things left at this point to treat are carbon dioxide (CO₂), nitrogen gas, water and oxygen. In order to reduce the carbon dioxide (CO₂) emissions as well as provide calcium carbonate (CaCO₃) for the wet scrubber, the exhaust gas is passed through the reaction chamber 18 that has calcium hydroxide (Ca(OH)₂ added therein. In the subject embodiment, the volume of calcium hydroxide (Ca(OH)₂ needed is approximately 962 g per 2380 L of incoming exhaust gas from the power plant 12. Within the reaction chamber 18, the chemical reaction of the calcium hydroxide (Ca(OH)₂ and carbon dioxide (CO₂), as set forth above, generates the calcium carbonate (CaCO₃) and water as needed in the wet scrubber 14. During this chemical reaction, the carbon dioxide (CO₂) level is reduced to trace amounts. During the chemical reaction within the reaction chamber 18, for every 285.88 L of carbon dioxide (CO₂), it requires 953 g of calcium hydroxide (Ca(OH)₂. When the exhaust gas from the power plant 12 is low in sulfur, excess calcium carbonate (CaCO₃) is being generated in the reaction chamber 18. Consequently, if the exhaust gas from the power plant 12 is higher in sulfur, the extra sulfur can be readily removed due to the extra calcium carbonate (CaCO₃) being produced. This would not require extra calcium hydroxide (Ca(OH)₂ since the amount of carbon dioxide has not been changed. Furthermore an additional volume of the by-product gypsum will be produced.

In conclusion, this process addresses the issues of nitrogen oxide (NOₓ), sulfur oxide (SO₂), and carbon dioxide (CO₂) emissions. Nitrogen oxides (NOₓ) are removed through the catalytic converter 16 and the removal is further enhanced by using platinum as a catalyst and generating nitrogen gas (N). The carbon dioxide (CO₂) is removed by reacting it with the calcium hydroxide (Ca(OH)₂ to produce the calcium carbonate (CaCO₃) that is used in the wet scrubber 14.

Other embodiments as well as certain variations and modifications of the embodiment herein shown and described will obviously occur to those skilled in the art upon becoming familiar with the underlying concept. It is to be understood, therefore, that the subject design, as claimed, may be practiced otherwise than as specifically set forth above.

What is claimed is:

1. A process for gas clean-up of a fossil fuel fired power plant, comprising the steps of:
directing the exhaust gas from the fossil fuel fired power plant through a wet scrubber;
adding a chemically produced compound from another source to the wet scrubber;
adding water from a remote source to the wet scrubber to mix with the exhaust gas and the chemically produced compound;
bypassing a chemically produced byproduct from the wet scrubber;
directing the chemically modified exhaust gas through a catalytic converter to further chemically modify the exhaust gas from the wet scrubber;
directing the further chemically modified exhaust gas to a reactor chamber for additional modification;
adding a reacting compound to the reaction chamber to aid in the additional modification of the exhaust gas therein;
bypassing the chemically produced product from the reactor chamber to the wet scrubber to severe as the another source noted above; and
exhausting the final chemically modified exhaust gas to the atmosphere.

2. The process as set forth in claim 1 wherein the exhaust gas from the fossil fuel fired power plant contains various percentages of carbon dioxide, water, nitrogen sulfur dioxide, and nitrogen oxides.

3. The process as set forth in claim 2 wherein in the step of adding a chemically produced compound from another source, the added chemical compound is calcium carbonate.

4. The process as set forth in claim 3 wherein the wet scrubber contains a mixture contains a mixture of water, calcium carbonate, and the exhaust gas from the fossil fuel fired power plant to produce a chemical reaction therein.

5. The process as set forth in claim 4 wherein in the step of generating a chemically produced by-product, the chemically produced by-product is a gypsum slurry.

6. The process as set forth in claim 5 wherein in the step of directing the chemically modified exhaust gas through the catalytic converter, any nitrogen oxides in the modified exhaust gas chemically converts to nitrogen gas and oxygen, residual carbon monoxide converts into carbon dioxide and residual hydrocarbons converts into carbon dioxide and water.

7. The process as set forth in claim 6 wherein the catalytic converter is a platinum catalytic converter with a honey comb arrangement.

8. The process as set forth in claim 1 wherein in the step of adding a reacting compound to the reaction chamber, the added reacting compound is calcium hydroxide.

9. The process as set forth in claim 8 wherein the chemical reaction in the reaction chamber produces calcium carbonate and water thus reducing the carbon dioxide content in the additionally modified exhaust gas.

10. The process as set forth in claim 9 wherein the calcium carbonate chemically produced in the reaction chamber is the remote source of calcium carbonate directed to the wet scrubber to mix with the water and the exhaust gas therein.

11. The process as set forth in claim 1 wherein in the step of exhausting the final chemically modified exhaust gas from the reaction chamber to the atmosphere, the chemical make-up of the final exhaust gas contains nitrogen, water, oxygen, and trace amounts of carbon dioxide.

12. The process as set forth in claim 1 wherein the fossil fuel is one of oil, natural gas and coal.

13. The process as set forth in claim 12 wherein the fossil fuel is coal.
